(19) United States
(12) Patent Application Publication
(10) Pub. No.: US 2006/0259426 A1
(43) Pub. Date: Nov. 16, 2006

(54) Apparatus and method for producing electronic media on demand

(76) Inventor: Michael J. Blama, Elkton, MD (US)

Correspondence Address: RATNERPRESTIA, P O BOX 980, VALLEY FORGE, PA, 19482-0980, US

(21) Appl. No.: 11/433,347

(22) Filed: May 12, 2006

Related U.S. Application Data
(60) Provisional application No. 60/680,122, filed on May 12, 2005.

(51) Int. Cl. G06Q 40/00

(52) U.S. Cl. 705/40

(57) ABSTRACT

A device for downloading electronic media to a consumer device is disclosed. The device includes a payment interface and a display interface electronically connected to the payment interface to display information. An input interface is electronically connected to the display interface to allow for selection of electronic media from the display interface. A storage device that stores the electronic media is electronically connected to the input interface and a download device is electronically connected to the storage device for downloading the electronic media from the storage device to a consumer device. A delivery area comprising a keyed entry space receives the consumer device after the electronic media has been downloaded to the consumer device. A key dispenser is electronically connected to the input interface to dispense a key after selection of the electronic media. A method of operating the device is also disclosed.

### CROSS-REFERENCE TO RELATED APPLICATION

The present application claims priority from U.S. Provisional Patent Application Ser. No. 60/680,122, filed on May 12, 2005.

### FIELD OF THE INVENTION

The present invention relates to an apparatus and method for manufacturing electronic media, such as CD's and DVD's, on demand.

### BACKGROUND OF THE INVENTION

Compact discs (CD's) and Digital Versatile Discs (DVD's) (also referred to as Digital Video Discs) are currently popular media for storing large quantities of music and video data on a relatively small medium. The quantity of data stored on such a small device is one of the reasons for the popularity of these media. However, the small size of the media has posed problems for retailers in the prevention of theft of these discs from their stores. Theft of such items costs retailers several millions of dollars every year. Retailers have resorted to inordinately large packaging in order to attempt to dissuade shoplifters from stealing the discs. However, the large packaging is expensive and takes up excessive space, resulting in higher shipping costs.

One attempt to reduce the size of CD and DVD packaging is to place electronic sensors on or in the packaging to alert store owners if the packaging is removed from the store without the sensors being deactivated at the check-out counter. Shoplifters have circumvented this security measure, however, by sneaking CD's and DVD's to areas of low security presence, such as a restroom, breaking the packaging open, and taking only the disc, leaving the packaging with the sensor in the store.

Another such anti-theft method is to utilize Radio Frequency Identification (“RFID”) technology to alert storeowners to thefts. RFID is the process of reading a microchip or circuit by sending radio waves from a scanning device. The microchip or circuit responds with a unique code. Because radio waves can be reflected or defeated by shielding the item containing the microchip or circuit with metal foils, however, this system is not foolproof.

Still another method to reduce the likelihood of loss of CD's and DVD's through shoplifting is to provide them through mail order. However, such a process can take several weeks to deliver an ordered item, and eliminates the ability of the consumer to simply browse for CD's or DVD's from selections “on the rack.”

An additional issue facing the CD and DVD retailers is overstocking and understocking. When an item is overstocked, the item languishes on the shelf for extended periods of time, taking up valuable sales floor space. When it is determined that the CD or DVD will never sell for its original asking price, it is marked down in price, sometimes to a price less than the wholesale price that the retailer paid, resulting in a sales loss, assuming the retailer manages to sell the item. Conversely, when an item is understocked, the retailer sells all of that particular item, with the potential to have sold more of the item if the retailer had more of the item in stock. With the item out of stock, consumers will often go to a different retailer to purchase the item, resulting is lost sales and revenue to the retailer.

It would be beneficial to provide a method of providing CD's and DVD's to consumers in a retail environment on demand while reducing the risk of loss of the CD's and DVD's to theft.

### BRIEF SUMMARY OF THE INVENTION

A device for downloading electronic media to a consumer device is provided. One exemplary embodiment of the present invention comprises a payment interface and a display interface electronically connected to the payment interface to display information upon registering a payment. An input interface is electronically connected to the display interface to allow for selection of electronic media from the display interface. A storage device is electronically connected to the input interface. The storage device stores the electronic media. A download device is electronically connected to the storage device for downloading the electronic media from the storage device to a consumer device. A delivery area receives the consumer device after the electronic media has been downloaded to the consumer device. The delivery area further comprises a keyed entry space. A key dispenser is electronically connected to the input interface to dispense a key after selection of the electronic media from the display interface.

An embodiment of the present invention further provides a device for downloading electronic media to a consumer device. The device comprises means for a user to interface with the device. A storage device is electronically connected to the means for the user to interface with the device. The storage device stores the electronic media. The device further comprises means for downloading the electronic media from the storage device to the consumer device. A delivery area is adapted to receive the consumer device after the electronic media has been downloaded to the consumer device. The device also comprises means for allowing a user to remove the consumer device from the delivery area and means for encoding the user's personal encryption information onto the consumer device.

Further, another exemplary embodiment of the present invention provides a method for obtaining electronic media from a media dispenser. The method comprises a user providing a payment into a payment interface in the media dispenser; the media dispenser registering the payment and displaying selection information to the user; the user providing at least one input into the media dispenser to make a selection; the media dispenser dispensing a key to the user; the media dispenser downloading the selection from a storage location to a consumer device; and the consumer using the key to obtain the consumer device from the media dispenser.

### BRIEF DESCRIPTION OF THE DRAWINGS

The accompanying drawings, which are incorporated herein and constitute part of this specification, illustrate embodiments of the present invention, and, together with the general description given above and the detailed description given below, serve to explain the features of the invention. In the drawings:

FIG. 1 is a schematic drawing of a device for producing electronic media on demand according to an exemplary embodiment of the present invention;

FIG. 2 is a schematic drawing of an exemplary embodiment of a network incorporating a plurality of the devices shown in FIG. 1;

FIG. 3 is a schematic drawing of a second embodiment of a network incorporating a plurality of the devices shown in FIG. 1;

FIG. 4 is a schematic drawing of a user interface of the device of FIG. 1; and

FIGS. 5A-5B is a flowchart showing operation of the device of FIG. 1.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

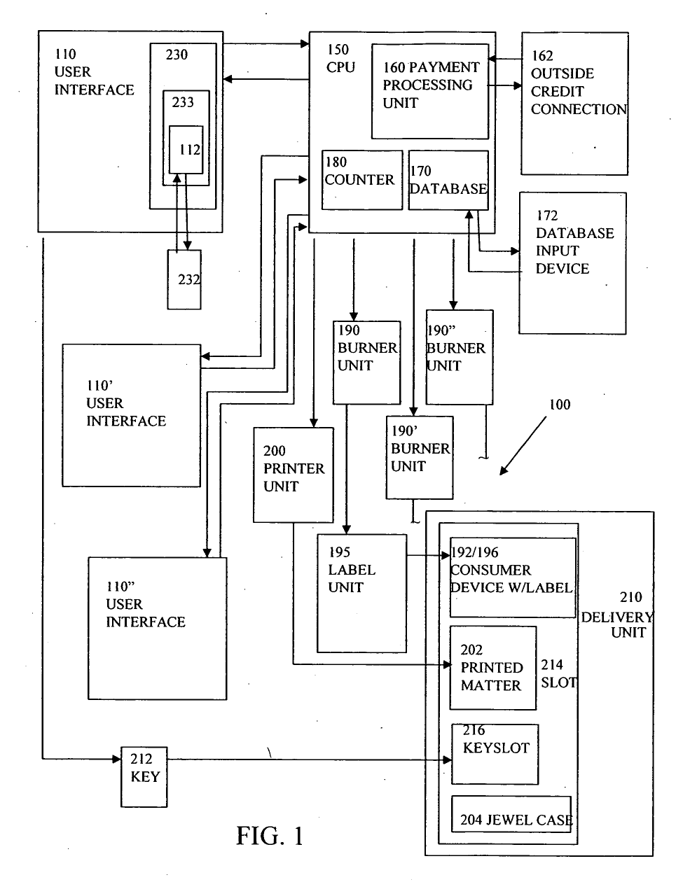

Referring to FIG. 1, a schematic drawing of an exemplary electronic media downloading device 100 is shown. Device 100 is used to transfer electronic media from a large database to an end user, such as a consumer, preferably for a fee. The electronic media can be music, videos, games, photos, software, or any other electronic media that can or will be able to be downloaded from a first main storage facility to a second device, such as a CD, a DVD, an iPOD®, an MP3 player, a personal computer, a cell phone, or other electronic device. The second device may be in the form of a card that includes a processor built into the card, along with memory storage in the card, which is read by the processor.

Device 100 may be located within a store, such as a department or a discount store. Alternatively, device 100 may stand-alone, such as at a kiosk in a mall. Alternatively, device 100 may be accessed electronically through the Internet. The media to be downloaded may be downloaded directly to a portable device or alternatively, may be downloaded to a relatively non-portable device, such as a personal computer, for later possible download to a portable device by the consumer.

Device 100 includes a user interface 110 that is electronically connected to a Central Processing Unit (“CPU”) 150. CPU 150 is electronically connected to a burner unit 190 that transmits selected information from CPU 150 to a consumer device 192. As used herein, the term “burner unit” may be any device that transmits electronic information from one unit or article to another unit or article. Further, the term “burn” may be any process or method used to transmit electronic information from one unit or article to another unit or article.

CPU 150 is also electronically connected to a printer unit 200 that prints any printed matter 202 that is associated with consumer device 192. Burner unit 190 and printer unit 200 are each linked to a delivery unit 210 that delivers finished consumer device 192 and any associated printed matter 202 to the consumer.

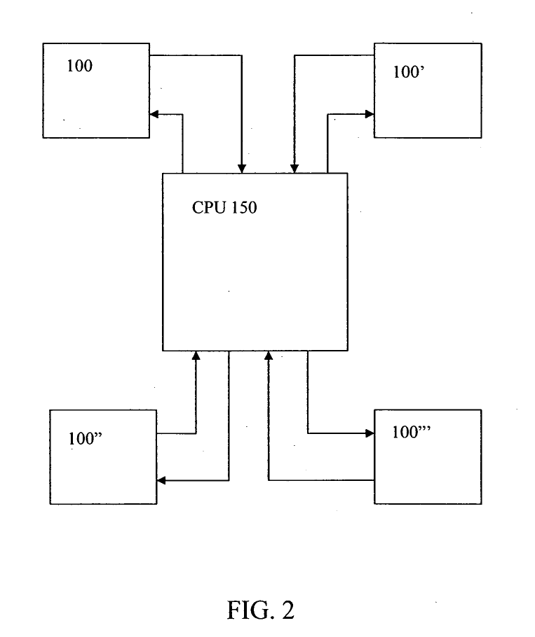

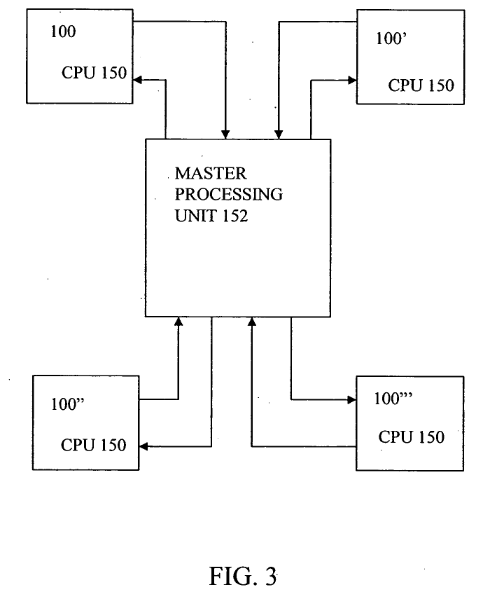

Each individual device 100 may be a part of a larger network that shares CPU 150, as shown schematically in FIG. 2. Alternatively, as shown in FIG. 3, each device 100 may have its own CPU 150, with connections from each CPU to a master processing unit 152.

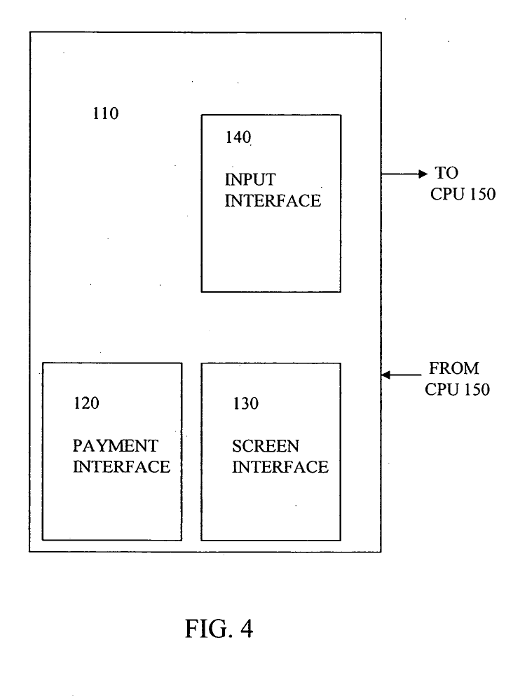

Referring now to FIG. 4, user interface 110 includes a payment interface 120. Payment interface 120 may be a card reader for reading a credit card, a debit card, a gift card, or any type of electronic card (not shown) that can impart payment information to device 100. Payment interface 120 need not necessarily be a reader, but any device that can transmit electronic information from a consumer's card to CPU 150. Alternatively, payment interface 120 may be a cash interface, such as a coin slot and/or a bill slot. Still alternatively, payment interface 120 may include a keyboard or other type of input for manually inputting information from the electronic card. Payment interface 120 may be electronically connected to CPU 150 via internal electronics, telephone or fiber optic lines, or via the Internet. If the consumer is accessing device 100 from a location physically remote from device 100, user interface 110 may be a computer, a cell phone, or some other remote electronic device.

User interface 110 may also include a screen interface 130 for displaying information to the consumer. Screen interface 130 may display such information as media selections that are available to the consumer, media selections that have been made by the consumer during the present or a previous transaction, an amount of space remaining for downloading additional media selections, an amount of money inserted by the consumer, an amount of money remaining for the consumer, or other such information that may be necessary or useful to the consumer to operate device 100.

Additionally, user interface 110 may also include an input interface 140 to allow the consumer to input information into device 100. User interface 110 may include a keyboard, a joystick, a touch screen, a computer mouse or touchpad, a microphone for voice input, or any other interface that allows the consumer to input information into device 100.

Input interface 140 allows the consumer to manipulate screen interface 130 to view different selections and to otherwise navigate around screen interface 130. Input interface 140 allows the consumer to select an item, such as an album, a movie, a game, a software program, or any other electronic media, for total copying onto consumer device 192. Alternatively, input interface 140 may allow the consumer to select individual songs from different albums to form a “compilation” to be copied onto consumer device 192.

Optionally, input interface 140 allows for the input of the consumer's cell phone or pager number to device 100 so that device 100 can transmit a signal to the cell phone or pager to notify the consumer that consumer device 192 is ready for pick up. Alternatively, after the cell phone or pager number is input into device 100, device 100 will be able to transmit a signal to the cell phone or pager to notify the consumer of new selections that are or will soon be available on device 100. This feature allows the consumer to shop while consumer device 192 is being burned.

User interface 110 is electronically connected to CPU 150. Those skilled in the art will recognize that multiple user interfaces 110, 110′, 110″ etc., may be electronically connected to the same CPU 150. Multiple user interfaces 110, 110′, 110″ etc. may be located proximate to each other, or multiple user interfaces 110, 110′, 110″ may be located remotely from each other.

CPU 150 includes multiple subunits for processing information and tasks related to operation of device 100. Referring back to FIG. 1, the subunits may include a payment processing unit 160, a database storage unit 170, and a counter unit 180.

CPU 150 may be located physically with or proximate to user interface 110. Alternatively, part of or all of CPU 150 may be located remotely from user interface 110.

Payment processing unit 160 receives input from payment interface 120 to process the consumer's payment for use of device 100. Payment processing unit 160 may include a connection 162 to a credit card and/or a bank database to process credit and debit card inputs. Payment processing unit 160 may also include a calculator to determine the number of selections that a consumer can select based on payment information, as well as a number of selections remaining after one or more selections have been made. After payment processing unit 160 processes a payment received from payment interface 120, payment processing unit 160 transmits a signal to screen interface 130 to inform the consumer that the consumer may input selections via input interface 140. Input received from input interface 140 queries CPU 150 for available selections, which are displayed to the consumer through screen interface 130.

Storage database 170 stores all of the media information available for downloading to consumer device 192. Storage database 170 allows for additions and deletions to the media information available, which can be accomplished via a database input device 172. Database input device 172 allows for access to storage database 170 by an authorized user, such as a database manager. The media information that can be input into storage database 170 includes, but is not limited to, music, videos, games, photos, software, and any other type of information that can be electronically stored.

Preferably, CPU 150 also includes counter unit 180 that provides totals of the different selections of media that are downloaded from device 100. Such counter unit 180 is important in determining sales volume as well as royalty payments that may be payable to copyright owners for media that is licensed to the owner of the device 100. Additionally, counter unit 180 may be used to advertise popular selections on screen interface 130, as well as to determine unpopular selections that may be selected for removal from storage database 170 in order to make room for new selections.

Burner unit 190 receives an input from CPU 150, and more specifically, from storage database 170 for downloading electronic data onto consumer device 192. The input is based on the selections input by the consumer at input interface 140. For example, if the consumer selects an entire album for copying, storage database 170 transmits the electronic data for the entire album to burner unit 190 to be burned onto consumer device 192.

Burner unit 190 is preferably a high speed burner, such as is used in the recording industry to mass produce CD's and DVD's for retail sale. Device 100 may include one burner unit 190 for each user interface 110, 110′, 110″ present with device 100. A typical device 100 in a retail environment may include at least three user interfaces 110, 110′, 110″ and three associated burner units 190, 190′, 190″.

A stack of consumer devices 192, such as blank CD's or DVD's, are typically pre-loaded into device 100. An individual consumer device 192 is automatically loaded into a particular burner unit 190 upon receiving a signal from CPU 150 that a consumer has purchased consumer device 192. Upon receiving the electronic information relating to the consumer's selections from storage database 170, burner unit 190 burns the electronic data onto consumer device 192.

Preferably, after burner unit 190 burns the electronic data onto consumer device 192, consumer device 192 is transferred to a label unit 195, where a label 196 is printed onto consumer device 192. Label 196 may be an adhesive-based label that is affixed to consumer device 192, or label 196 may be directly printed onto a surface of consumer device 192. CPU 150 transmits electronic information to label unit 195 to print label 196 onto consumer device 192. Optionally, label unit 195 may be omitted and label 196 may be printed directly onto consumer device 192 by burner unit 190.

Printer unit 200 receives an input from CPU 150 based on the selections made by the consumer at input interface 140. For example, if the consumer selects an entire album for copying, storage database 170 transmits the electronic data for the printed matter associated with that album to printer unit 200 for printing. Such data may include jewel case artwork, lyrics, copyright information, and any other such information that is associated with the selected album. Printer unit 200 prints the associated data onto a print medium, forming printed matter 202.

After burner unit 190 produces consumer device 192 and label unit 195 prints label 196 onto consumer device 192, consumer device 192 is transported to a delivery unit 210 for the consumer to pick up consumer device 192. Printed matter 202 is also transported to delivery unit 210 for the consumer to pick up printed matter 202 with consumer device 192. Also, a jewel case 204 may be transported to delivery unit 210 for the consumer to pick up jewel case 204 with consumer device 192 and printed matter 202.

Preferably, delivery unit 210 is made up of several slots 214 so that multiple consumer devices 192 may be available for their respective consumer purchasers. Each slot 214 is individually accessible by a matching key 212 that is provided to the consumer from user interface 110. The consumer inserts key 212 into a keyslot 216 in respective slot 214 at delivery unit 210. Key 212 may be an electronic card that is encoded with the consumer's purchase information, such as selections made, purchase information, and any other necessary or useful information. Key 212 may serve as a receipt and proof of the consumer's purchase of the selections made. The consumer may be able to swipe key 212 through keyslot 216 and retain possession of key 212. Alternatively, the consumer may be required to insert key 212 into keyslot 216, with key 212 being irretrievable by the consumer after insertion into keyslot 216. If so, the consumer may be furnished with an additional receipt that the consumer may keep as proof of the transaction.

Device 100 may also include an encryption system 230. Encryption system 230 substantially reduces piracy of consumer device 192 after its purchase. During the purchase transaction, the consumer inserts a portable encryption key 232 into an encryption card slot 112 at user interface 110. Preferably, encryption key 232 is physically similar to a memory card presently used in digital cameras, for example.

Encryption key 232 is usable with a playback device, such as a CD player, a DVD player, a personal music player, such as an iPOD®, a game station, or a personal computer (not shown), that only allows playback of consumer devices 192 that are associated with the encryption data on encryption key 232. Such an encryption system 230 prevents the consumer from purchasing consumer device 192, making copies of consumer device 192, and selling the copies to other consumers, since the other consumers will not have access to the encryption data on encryption key 232. Encryption system 232 also precludes simultaneous playing of consumer devices 192 encoded with identical encryption codes in different playback devices.

An encryption card reader 233 in device 100 reads encryption key 232 and transmits the encryption data on encryption key 232 to CPU 150. The encryption data is incorporated by CPU 150 onto consumer device 192, such as at the beginning of the burning process. After consumer device 192 is burned, the information on consumer device 192 will only be able to be read by a playback device into which encryption key 232 has been inserted. For example, if the consumer desires to play consumer device 192 on his/her CD player, the consumer must first insert encryption key 232 into an encryption card reader on that CD player.

If the consumer later desires to play consumer device 192 on another playback device, such as his/her personal computer, the consumer must take encryption key 232 from the CD player and insert encryption key 232 into the personal computer in order to be able to play consumer device 192. If a user, who is either the consumer or a third party, attempts to use consumer device 192 without encryption key 232 in the playback device, that playback device will only read a series of meaningless bits of information, and the user will not be able to enjoy the benefits of consumer device 192.

Encryption key 232 may be provided to the consumer with the purchase of an electronic device, such as a CD player, a DVD player, and the like, which all are equipped with unique identifying serial numbers. In that way, in the event that the consumer loses his/her encryption key 232, a duplicate encryption key 232 can be generated based on the consumer's identity. The electronic keys include an embedded microchip that is verified before allowing further processing. Desirably, encryption key 232 is verified before the data on consumer device 192 is read by the device into which consumer device 192 is inserted.

Device 100 may be manufactured and provided to a retailer with encryption system 230 installed in device 100, but with encryption system 230 able to be switched between “inactive”, prior to the availability of electronic devices with the encryption technology built in, and “active”, after such devices with the encryption technology become widely available.

In use, device 100 is placed in a location that is readily accessible to the consumer, such as in a retail or discount store, or freestanding in a mall. A plurality of devices 100 may be located adjacent to each other to allow multiple consumers to simultaneously access devices 100.

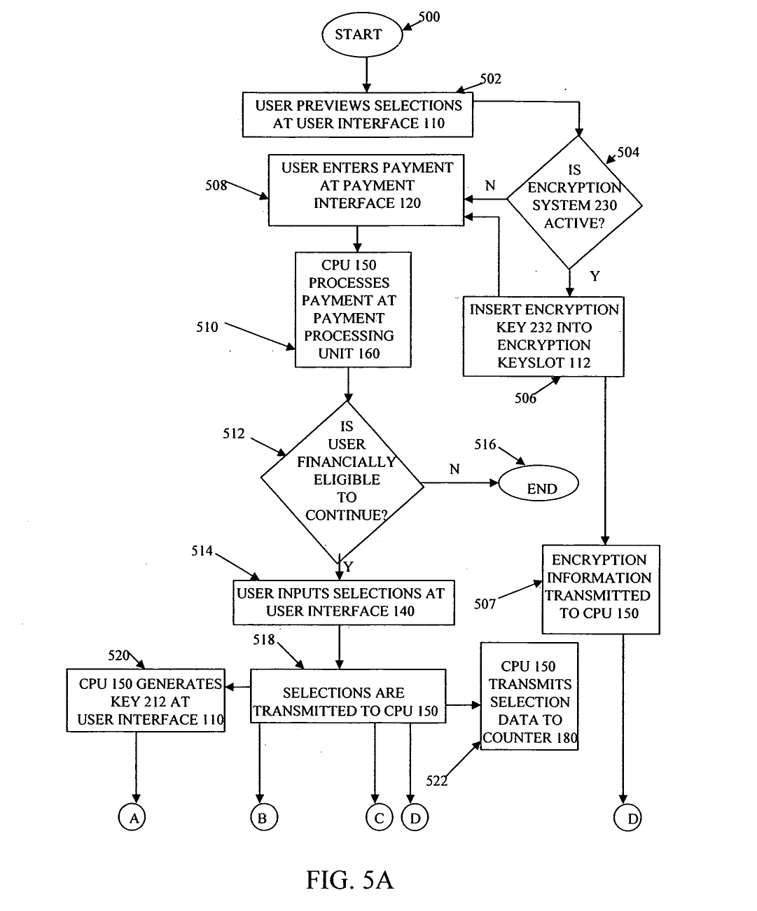

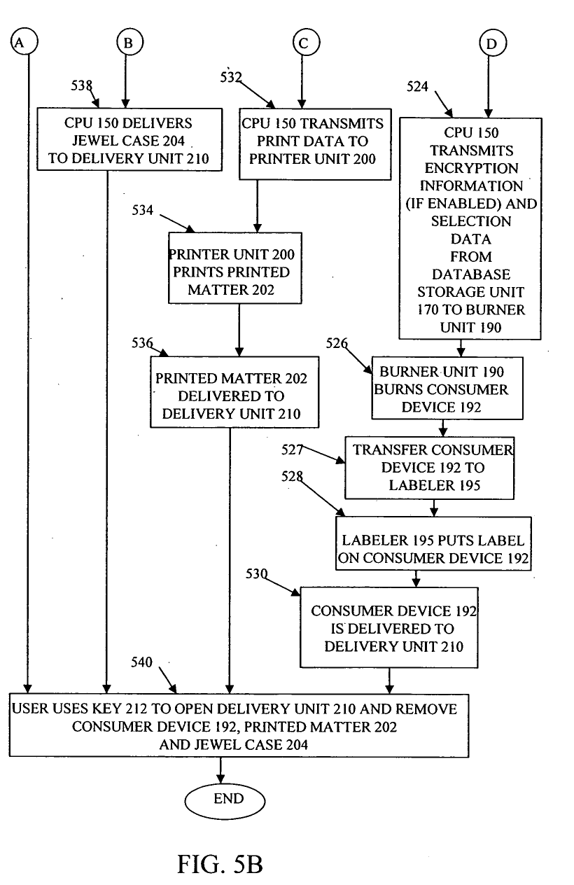

Referring now to the exemplary flowchart of FIGS. 5A and 5B, the consumer approaches device 100 to start at Step 500. At Step 502, the user manipulates user interface 110 to preview the selections that are available from database 170. When the consumer desires to purchase one or more selections from device 100, if encryption system 230 is activated (as determined at Step 504), Step 506 is entered, otherwise Step 508 is entered without the benefit of encryption. At Step 506, user interface 110 instructs the consumer to insert his/her personal encryption key 232 into encryption card slot 112 in user interface 110. At step 507, the encryption information is transmitted from encryption key 232 to CPU 150.

In parallel with the process above with respect to Steps 506, etc, at Step 508, after encryption key 232 is inserted into encryption card slot 112, the consumer makes a payment at payment interface 110. The payment may be made by using an electronic card, although actual money may be used instead. At Step 510, payment interface 110 transmits the payment information to payment processing unit 160 of CPU 150. At Step 512, payment processing unit 160 queries the consumer's account to verify credit availability and/or funds balance.

Assuming that the consumer is financially eligible to continue, CPU 150 transmits an affirmative message to the consumer to inform the consumer that he/she is able to make selections. At Step 514, using input interface 140, the consumer determines the selection(s) that he/she desires at this time. At Step 516, if the consumer is financially ineligible to continue, CPU 150 ends the transaction.

When the consumer has made his/her selections, at Step 518 those selections are transmitted to CPU 150. At step 520, CPU 150 recognizes and accepts the selection information from the consumer and electronically generates key 212. The consumer subsequently picks up key 212 from user interface 110 (not shown).

Optionally, CPU 150 transmits a signal to screen interface 130 to inform the consumer of an approximate time when consumer device 192 will be ready for pick up at delivery unit 210. Alternatively, the consumer may be able to input cell phone and/or beeper information into CPU 150 through input interface 140 so that CPU 150 may be able to transmit a wireless signal to the consumer to inform him/her that consumer device 192 is ready for pick up at delivery unit 210.

As CPU 150 recognizes and accepts the consumer's selection(s), the selection data is transmitted to counter unit 180 at Step 522. Counter unit 180 counts the selection(s) that the consumer has made and adds the selection(s) to prior selection information provided by previous consumers. At predetermined intervals (daily, weekly, monthly, etc.), the data stored in counter unit 180 is retrieved and processed for royalty payments and for other uses as are deemed necessary by the owner of device 100.

At Step 524, CPU 150 transmits data from database storage unit 170 to burner unit 190 to transfer the selection information onto consumer device 192. Additionally, if the encryption system 230 is active (see Step 504 above) CPU 150 also transmits the encryption information from database storage unit 170 to burner unit 190. Desirably, a stack of consumer devices 192 is preloaded into device 100 proximate to burner unit 190. One of consumer devices 192 from the stack is loaded into burner unit 190. At step 526, if encryption system 230 is active, consumer device 192 is first burned with encryption data from encryption key 232, after which consumer device 192 is burned with the data information downloaded to burner unit 190, otherwise consumer device 192 is burned with the data information downloaded to burner unit 190 without the benefit of encryption.

At Step 527, when the burning of consumer device 192 is complete, completed consumer device 192 is transmitted to labeler 195. At step 528, Labeler 195 applies label 196 to the top of consumer device 192. Label 196 may be adhesive-based and stuck onto the top of consumer device 192. However, label 196 may alternatively by printed directly onto the top of consumer device 192. At step 530, after consumer device 192 is burned and labeled, completed consumer device 192 is transported to a pre-selected slot 214 in delivery unit 210.

At Step 532, CPU 150 also transmits printing data to printer unit 200. At Step 534, printer unit 200 prints printed matter 202 associated with selected consumer device 192, such as artwork, lyrics, credits, and any other information that may be required, as will be recognized by those skilled in the art. At step 536, after printed matter 202 is finished, printed matter 202 is transported to same slot 214 in delivery unit 210 as consumer device 192.

Additionally, protective cover 204, such as a jewel case, may be provided to the consumer to store and protect consumer device 192. Protective cover 204 may be delivered to delivery unit 210 at step 538 with consumer device 192 and printed matter 202 so that the consumer can place consumer device 192 into protective cover 204 immediately upon removal of consumer device 192 from slot 214.

At step 540, when consumer device 192, printed matter 202 (optional), and protective cover 204 (optional) have been delivered to delivery unit 210, the consumer is able to insert key 212 into keyslot 216 to open delivery unit 214 and remove device 192, and the optional printed matter 202 and protective cover 204.

Because the consumer has already paid for consumer device 192, the consumer will be able to take consumer device 192, with any associated printed matter 202 and/or protective cover 204 from the purchase location without having to pay at a sales counter.

While the above consumer transaction is envisioned to occur with the consumer at a retail store, those skilled in the art will recognize that the consumer transaction described in FIGS. 5A-5B may also take place with the consumer at his/her home computer or some other location away from a retail site. In this type of transaction, the consumer can “pre-order” consumer device 192 for later pick up at the retail store where delivery unit 210 is located.

Still alternatively, CPU 150 can transmit the consumer's selections to the consumer's computer via the Internet, allowing the consumer to burn the CD on his/her CD burner at a later time, while still allowing the copyright owner to be paid his/her royalty through counter unit 180. Alternatively, other types of formats, such as MP3, may be used to store more electronic data downloaded from CPU 150 into a smaller space.

Although the burning of CD's is described above, the invention is not so limited. It is also possible to use the above system to select and burn data (audio and or video) onto a DVD, for example, in any one of a variety of formats.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A device for downloading electronic media to a consumer device comprising:
a payment interface;
a display interface electronically connected to the payment interface to display information upon registering a payment;
an input interface electronically connected to the display interface to allow for selection of electronic media from the display interface;
a storage device electronically connected to the input interface, wherein the storage device stores the electronic media;
a download device electronically connected to the storage device for downloading the electronic media from the storage device to the consumer device;
a delivery area adapted to receive the consumer device after the electronic media has been downloaded to the consumer device, wherein the delivery area further comprises a keyed entry space; and
a key dispenser electronically connected to the input interface to provide a key after selection of the electronic media from the display interface.

2. The device according to claim 1, wherein the key provides for access to the keyed entry space.

3. The device according to claim 1, further comprising an encryption device configured to download encryption information onto the consumer device.

4. The device according to claim 3, wherein the input interface comprises a encryption card slot.

5. The device according to claim 1, wherein the storage device is located remotely from the input interface.

6. The device according to claim 1, wherein the consumer device is a portable device.

7. The device according to claim 6, wherein the portable device is a disc.

8. The device according to claim 1, wherein the download device is located remotely from the storage device.

9. The device according to claim 1, further comprising a print device electronically connected to the storage device, wherein the print device prints matter associated with the electronic media.

10. A device for obtaining electronic media from a media dispenser comprising:
means for providing a payment from a user into a payment interface in the media dispenser;
means for registering the payment in the media dispenser and displaying selection information to the user;
means for providing at least one input from the user into the media dispenser to make a selection;
means for dispensing a key from the media dispenser to the user;
means for downloading the selection from a storage location to the consumer device; and
means for obtaining the consumer device from the media dispenser.

11. The device according to claim 10, wherein the electronic media is selected from the group consisting of music, video, computer software, and games.

12. The device according to claim 10, further comprising means for encoding a portable encryption key.

13. The device according to claim 10, wherein the means for obtaining the consumer device from the media dispenser comprises a key.

14. The device according to claim 10, wherein the consumer device is a portable device.

15. The device according to claim 14, wherein the portable device is a disc.

16. The device according to claim 10, further comprising means for printing matter associated with the electronic media.

17. The device according to claim 10, wherein the means for providing at least one input into the media dispenser further comprises an encryption key slot.

18. A method for obtaining electronic media from a media dispenser comprising:
providing a payment from a user into a payment interface in the media dispenser;
registering the payment in the media dispenser and displaying selection information to the user;
providing at least one input from the user into the media dispenser to make a selection;
dispensing a key from the media dispenser to the user;
downloading the selection from a storage location to the consumer device; and
obtaining the consumer device from the media dispenser.

19. The method according to claim 18, further comprising, after providing the at least one input into the media dispenser, printing printed matter associated with the selection.

20. The method according to claim 18, further comprising downloading encryption information from the media dispenser onto the consumer device.
